(19) United States
(12) Patent Application Publication
(10) Pub. No.: US 2005/0230868 A1
(43) Pub. Date: Oct. 20, 2005

(54) Method for manufacturing slabs made of stone-like agglomerated material having an aged upper surface

(76) Inventor: Roberto Dalla Valle, Bussolengo (IT)

Correspondence Address: Pablo E Tapia;Greenberg Traurig, 2450 Colorado Avenue, Suite 400E, Santa Monica, CA, 90404, US

(21) Appl. No.: 10/517,712

(22) PCT Filed: Feb. 2, 2004
(86) PCT No.: PCT/IT04/00036

§ 371 Date: Dec. 10, 2004

(30) Foreign Application Priority Data
Feb. 5, 2003 (IT) VR2003A000012

(51) Int. Cl. B29C 43/02

(52) U.S. Cl. 264/109; 264/319

(57) ABSTRACT

A method for obtaining antique-look slabs (10) made of stone agglomerate material has a first step of crushing the various materials of which the agglomerate consists, a second step of mixing the crushed materials, to obtain as homogeneous a product as possible, during which the binding resins are added, a third step of preparing a shaped die on the base of which there is a firset layer of paper, advantageously polyethylene-coated paper, a fourth step of pouring the crushed materials into the die, a fifth step of covering the pressed agglomerate material with a second layer of paper, advantageously polyethylene-coated paper, a sixth step of pressing and compacting the agglomerate, during which the desired shape is obtained, a seventh step of hardening the sheet or panel (10) at a predetermined temperature, an eighth step of separating the second layer of paper from the sheet (10), in which the second layer of paper is separated from the sheet (10) by simply lifting and removing the paper substantially in a single piece, leaving the sheet (10) with an antique-look surface (11) in view.

### TECHNICAL FIELD

The present invention relates to a method for obtaining antique-look slabs made of stone agglomerate material.

More specifically, the present invention relates to a method for obtaining slabs made of agglomerate material consisting of crushed pieces of stone compacted by means of binders, which can be used for the production of tiles, hobs and in general kitchen worktops, steps for staircases, etc., said sheets having an antique-look outer surface.

The invention applies mainly to the industrial processing sector for marble, stone, granite and the like.

### BACKGROUND ART

It is known that in order to obtain sheets made of agglomerate material, the following procedure is normally used:
a step of crushing the stone raw material,
a step of mixing the crushed stone raw material and an inert filler with a binder,
a step of pouring the mixture into a special die on the base of which there is a layer of special paper, normally polyethylene-coated;
a step of covering the mixture with another layer of special paper, normally polyethylene-coated;
a step of vibration and vacuum pressing of the mixture previously prepared;
a step of heating in an oven at a predetermined temperature and for a predetermined time, in order to obtain a binder catalysis reaction;
a step of removing, by grinding, the polyethylene-coated paper upper surface layer.

The sheets obtained from the firing step are then subjected to steps of polishing and/or cutting and/or chamfering and/or gauging and/or flaring.

Finally, as the last step the above-mentioned sheets may be cut to obtain pieces of a predetermined shape.

A process like the one described above makes it possible to obtain panels or sheets made of agglomerate material with lengths, widths and thicknesses which are precisely predetermined, and may be implemented continuously by a special plant.

The paper layer advantageously consists of polyethylene-coated paper comprising a layer of paper fixed to a polyethylene film by layers of adhesives. Improved results are achieved when using a paper support impregnated with polyethylene deposited by spraying.

One disadvantage is the fact that the panels obtained by die forming always require processing on machine tools in order to produce the desired configuration on the finished product and removal of the polyethylene-coated paper affects the cost of the finished product.

This final processing may also result in rejects which, considering that this is one of the final operations, have a considerable effect on the total production costs.

Moreover, such processing to remove shavings adds to the overall production times and creates dust and residues which are sometimes difficult to dispose of.

If the polyethylene-coated paper is to be detached from the sheet without using machine tools to remove it, the surfaces obtained would be quite irregular, having an original antique look.

In such cases, one disadvantage is the fact that the surface of the sheet below the polyethylene-coated paper is extremely porous, tending to retain liquid and dust residues present in the environment, with inevitable periodic build-ups of dirt.

Another disadvantage is the fact that this porosity accelerates corrosive phenomena which, over time, cause the sheet made of agglomerate material to break.

### DISCLOSURE OF THE INVENTION

The aim of the present invention is to provide a process for obtaining sheets made stone agglomerate material able to overcome or significantly reduce the above-mentioned disadvantages and having an antique look.

Another aim of the present invention is to provide an antique-look sheet made of stone agglomerate material which can be obtained with minimum cost and minimum waste and consumption of raw materials and processing tools.

This is achieved with a process for obtaining antique-look sheets having the features described in the main claim.

It is also achieved by means of an antique-look sheet made of stone agglomerate material having the features described in claims 6 to 8.

The dependent claims outline advantageous embodiments of the invention.

### DESCRIPTION OF THE DRAWINGS

Other features and advantages of the invention are evident in the description which follows of an embodiment of the invention, by way of example and in no way limiting the scope of application, with reference to the accompanying drawing, which illustrates a sheet made of antique-look agglomerate material obtained using a process disclosed.

### DESCRIPTION OF A PROCESS ACCORDING TO THE INVENTION

The process disclosed consists of the following steps:
a first step of crushing the various materials of which the agglomerate consists;
a second step of mixing the crushed materials, to obtain as homogeneous a product as possible, during which the binding resins are added;
a third step of preparation of a special die on the base of which there is a layer of special paper, advantageously polyethylene-coated paper;
a fourth step of pouring the crushed materials into the die;
a fifth step of covering the pressed agglomerate material with a second layer of special paper, advantageously polyethylene-coated paper;
a sixth step of pressing and compacting the agglomerate, during which the desired shape is obtained;
a seventh step of hardening the sheet or panel at a predetermined temperature;
an eighth step of separating the second layer of paper from the sheet made of agglomerate material obtained;
a ninth step of polishing the surfaces of the sheet; in which the step of separating the second layer of polyethylene-coated paper from the sheet is performed by simply lifting the paper in a single piece, leaving the sheet with an antique-look surface in view.

A process like the one described above makes it possible to obtain antique-look sheets or panels made of agglomerate material with lengths, widths and thicknesses which are precisely predetermined, and is implemented continuously by a special automated plant.

The production of an antique-look sheet made of stone agglomerate material according to the invention requires minimum resources in terms of processing times and tool consumption.

The antique-look sheet exits the die forming unit as a product which is almost finished, since polishing makes it possible to obtain, on the sheet, an impermeable surface layer needed to prevent any corrosion and the penetration of dirt into the pores of the material.

Simply lifting the upper layer of polyethylene-coated paper guarantees an antique-look surface on the sheet, highlighting irregularities in its shape (ridges and depressions) as well as slight cracks.

### DESCRIPTION OF THE DRAWINGS

Other features and advantages of the invention are evident in the description which follows of an embodiment of the invention, by way of example and in no way limiting the scope of application, with reference to the accompanying drawing, which illustrates a sheet made of antique-look agglomerate material obtained using a process disclosed.

### DESCRIPTION OF AN EMBODIMENT

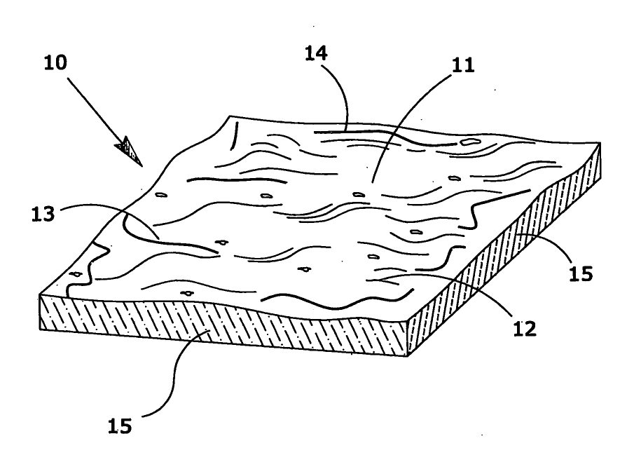

In FIG. 1, the reference number 10 generally indicates a sheet of stone agglomerate material, in the case in question a sheet 10 with an antique-look surface 11 in view.

The surface 11 has ridges 12 and depressions 13 which are evenly distributed and micro-cracks 14.

The plan of the sheet 10 may have a quadrangular configuration.

The edges 15 of the sheet 10 are smooth, regular and well squared so that the panel 10 can easily be used for immediate laying or for subsequent processing.

The invention is described above with reference to a particular embodiment. It is nevertheless clear that the invention is not limited to this embodiment but is also susceptible to numerous variations, within the framework of technical equivalents.

1-9. (canceled)

10. A method for obtaining a slab of agglomerate stone, comprising:
crushing a plurality of stone materials as to form an agglomerate;
mixing the crushed materials while simultaneously adding at least one binding resin as to obtain a homogeneous agglomerate mix;
pouring the homogenous agglomerate mix onto a shaped die until the shaped die is full as to form a panel of homogenous agglomerate mix, the shaped die having in the base a first layer of polyethylene-coated paper;
covering the shaped die with a second layer of polyethylene-coated paper;
pressing and compacting the panel of homogeneous agglomerate mix in the shaped die;
hardening the panel at a predetermined temperature; and
separating the second layer of polyethylene-coated paper from the panel by lifting and removing the second layer of polyethylene-coated paper substantially in a single piece, leaving the panel with an antique-look surface in view.

11. The method according to claim 1, further comprising polishing the panel to obtain an impermeable surface layer on the antique-look surface of the panel.

12. The method according to claim 2, wherein the panel is polished using titanium grinding wheels designed not to alter the configuration of the antique-look surface of the panel.

13. The method according to claim 1, wherein the polyethylene-coated paper is impregnated with sprayed polyethylene.

14. An agglomerate stone slab having evenly distributed ridges and depressions which provide an antique look, the agglomerate stone slab having an impermeable surface layer, the agglomerate stone slab having smooth, regular and squared edges, the agglomerate stone slab made by a method according to claim 1.

15. The method according to claim 5, wherein the polyethylene-coated paper is impregnated with sprayed polyethylene.
